(19) United States
(12) Patent Application Publication
(10) Pub. No.: US 2022/0410709 A1
(43) Pub. Date: Dec. 29, 2022

(54) WINDOW FRAME ELEMENT FOR A MOTOR VEHICLE

(71) Applicant: HUTCHINSON, PARIS (FR)

(72) Inventors: Bertrand FLORENTZ, PAUCOURT (FR); Sebastien POPINEAU, LA CHAPELLE LA REINE (FR); David BLANCHARD GOMES, LEVALLOIS PERRET (FR)

(21) Appl. No.: 17/781,108

(22) PCT Filed: Dec. 1, 2020
(86) PCT No.: PCT/EP2020/084024

§ 371 Date: May 31, 2022

(30) Foreign Application Priority Data
Dec. 2, 2019 (FR) 1913619
Dec. 2, 2019 (FR) 1913621

(51) Int. Cl. B60K 35/00; B60R 11/02

(52) U.S. Cl. CPC B60K 35/00; B60R 11/0235; B60K 2370/794

(57) ABSTRACT

A window frame element (30) for a vehicle (10), in particular a motor vehicle, said frame element being substantially horizontal and configured to extend, to the exterior of the vehicle, along a substantially horizontal edge of a window (20, 22) and in the extension of this window, this element comprising a body (32) configured to be carried by a support of the vehicle characterised in that it further comprises at least one screen (28) for displaying pixel information and a control and communication system (34), which is configured to receive first signals (36) and to transmit second signals (38) to said at least one screen (28), which is configured to display information in accordance with said second signals.

### TECHNICAL FIELD OF THE INVENTION

The present invention relates in particular to a window frame element for a vehicle, in particular a motor vehicle,

### TECHNICAL BACKGROUND

A motor vehicle comprises several windows which are framed or surrounded by elements in particular to ensure a sealing around the window and also to highlight the glass panes by giving them a more luxurious appearance with trim elements, for example typically chromed, brushed or glossy black. An example of such a frame element is a side licker of a window, which is an elongated frame element that extends along an edge of a window, usually movable, and which can ensure both a sealing with this window, its licking to clean the latter as it descends and rises (hence its name), as well as an aesthetic finishing. The frame element may also extend along a front (windshield) or rear (rear window) glass edge, and/or not be in direct contact with the glass pane as in the case of a cowl grille trim element located opposite the bottom of the windshield,

Conventionally, a frame element comprises a body at least partly elastically deformable and configured to be carried by a support of the vehicle and to sealingly cooperate with a member, such as a window. In the case of a licker, the elastic body is for example attached to a rack of a door of the vehicle and sealingly cooperates with the movable or stationary window of this door.

A motor vehicle is equipped with several information displays devices for the user of the vehicle. These devices are usually located inside the passenger compartment of the vehicle.

It has already been proposed to display information to the exterior of the vehicle, for example on a window of the vehicle. However, these technologies are relatively complex and expensive to implement.

It was also proposed that frame elements of the type mentioned above be equipped with lighting devices. However, these technologies do not allow to display precise and varied information, in particular because the lighting devices used are limited to the display of a light spot having a specific colour and/or shape.

In addition, the aesthetics of these solutions are also highly questionable, as they do not integrate harmoniously with the neighbouring members, such as the window or the door casing.

The invention allows to remedy at least some of the above problems with a solution that is simple, effective and economical and combines aesthetics and information display.

### SUMMARY OF THE INVENTION

The present invention relates to a window frame element for a vehicle, in particular a motor vehicle, this frame element being substantially horizontal and configured to extend, to the exterior of the vehicle, along a substantially horizontal edge of a window, and preferably in the extension of this window, and comprising a body configured to he carried by a support of the vehicle, characterised in that it further comprises at least one pixel information display screen and a control and communication system, which is configured to receive first signals and to transmit second signals to said at least one screen, which is configured to display information in accordance with said second signals.

The invention thus proposes to associate a display screen with a window frame element that virtually and visually extends the window, for example downwards, by a shiny surface of black appearance when it is switched off, and that can virtually enlarge the glass panes and allow the apparent shape of the glass panes of the vehicle to be changed. It is therefore also a new styling element that allows for a modelling of the vehicle design that the windows alone does not allow because of their vertical size and their shape are forced to drop and preferably disappear entirely into the door casing once they are open.

This screen is configured to display information and is therefore not a simple surface on which information is projected. The screen allows to virtually enlarge the glass pane surface area by extending it downwards, for example, and thus to improve the aesthetics (“design”) while providing information to the user. The screen in question is of the pixel type, i.e. it is not a single light spot or several light spots.

In the present application, “pixel” is understood to be a basic unit allowing for measuring the definition of a digital matrix image, i.e. organized in columns and rows. It is thus understood that the display screen comprises a matrix of pixels whose definition is selected according to the information to he displayed.

The invention allows to combine several functions in one place and one part of a vehicle, namely the frame element. The first function is the information display function through the screen, this solution being simple, effective and aesthetic and less expensive than other information display solutions. Another function is related to the improvement of the aesthetics of the window and therefore of the vehicle. The frame element is known to improve the finishing around a window and can be used, for example, to give the impression of a larger glass surface area.

The horizontal orientation of the frame element in use can allow to facilitate the display of certain information to the exterior of the vehicle, to a user, such as for example messages that can be read at a distance of several meters from the car. The frame element according to the invention may comprise one or more of the following characteristics, taken alone or in combination with each other:
said body has an elongated shape; said at least one screen is located on said body;
the frame element comprises a finishing trim element for a side window, the windshield or a rear window of a vehicle;
the frame element comprises an outer seal or licker of a side window of the windshield or a rear window of a vehicle;
the frame element further comprises a control and communication system, which is configured to receive first signals and to transmit second signals to said at least one screen, which is configured to display information according to said second signals;
said system is configured to communicate remotely, i.e. wirelessly;
said system is configured to communicate by wire connection with at least one element intended to be located at the interior or to the exterior of the vehicle;
said system is configured to communicate with at least one device selected from a cell phone or an application installed on a cell phone, a sensor, an actuator, a key, a data bus of the vehicle (e.g. CAN, MOST, LIN, FLEXRAY, ETHERNET), a mobile communication network, WIFI, Bluetooth, local or internet connected, a near field communicating object (NFC), etc.;
said sensor is a door locking/unlocking sensor, a door opening/closing, sensor, a window opening/closing sensor, a temperature sensor, a noise or voice sensor, an image or video sensor, a geographical position sensor, a proximity sensor, a radar, a lidar, a fingerprint sensor, a solar sensor or a thermoelectric material e.g, black allowing to generate current, etc,;
said actuator is an actuator allowing for the opening/closing or the locking/unlocking of a window, a door or doors, the appearance of a door handle, a loudspeaker or an electrodynamic or piezoelectric actuator allowing for sounding the surface of this framing to broadcast sounds, warnings, music or spoken messages, etc.;
the frame element is or comprises an outer licker or a finishing trim element for a side window of a vehicle, and for example for a side window of a side door of a vehicle; the trim element can be chromed, coloured, decorated, configured to highlight the circumference of a window, consisting of a light band emitted by the screen, etc.;
the frame element is a finishing trim element, for example, matching the framings of the other windows;
said at least one screen is at least partly tactile and/or said frame element comprises at least one tactile surface or a haptic, radar or video interface, recognizing and interpreting remote gestures, such as an information input keyboard for example;
said at least one screen is configured to display information selected from among an indication of opening and/or closing of door of the vehicle, an indicator of a charge level of a battery, in particular of the vehicle, a pressure of the tire or tires of the vehicle, a registration number, in particular of the vehicle, a message and/or an image that the user will have chosen to display on said screen from an electronic device connected thereto, in particular his cell phone or smartphone or a network of computer resources of the mobile or Cloud type, an information relative to the quality of the air inside the vehicle or the air outside, a communication SMS, an information in the form of text or colour code representing pollutant emissions, recommendations or gas discharges from the vehicle, an information on a preventive or urgent maintenance action to he carded out on the vehicle (deflated tires, oil level to be redone, wear of the brake pads/discs, technical inspection visit to be carded out on the parking, scheduled or to be scheduled on a particular date), an information on the condition of the bodywork of the vehicle in the context of a rental of the vehicle, the accessibility of the vehicle to persons with reduced mobility, an information on the distance between said vehicle and the vehicles parked on either side of said vehicle, in particular for the PRM requiring space, a regulatory information resulting from a toll, or an access right or an activation by the police, a countdown of the remaining parking time, in particular within the context of the payment for this parking, a coded information (OR Code, encrypted message, password) allowing to authorize the access of certain areas by an interrogation or visual validation of an outer device, a colour., a sign or a logo whose recognition triggers the validation of an access control (parking spaces reserved for categories of users, PRM, family, pollution category of the vehicle, zero-emission character of the vehicle on displacement, etc.), in the context of a rental car: a reservation number, a number of kilometres covered during, the contract, a number of authorized kilometres, a date and a time of return of the vehicle, etc.;
said at least one screen has a display surface area greater than 1 cm², and preferably greater than 10 cm², and/or a resolution or definition greater than or equal to 50 dpi (dots per inch);
said at least one screen extends over the entire length of the window to extend it virtually downwards and allolAi other shapes (virtual) of cut-out of the bottom of the windows;
the support of the vehicle runs along the glass panes of the vehicle and in particular said window;
the frame element comprises a plurality of screens for displaying different information;
said body and said at least one screen are covered by a layer that is at least partly transparent to visualize the displayed information through this layer preferably having a black glossy aspect when the screen is switched off;
said layer comprises an opaque portion, for example black or white, covering said body and a transparent or semi-transparent portion covering said at least one screen; this transparent or semi-transparent portion is for example tinted in grey to give a continuous and uniform glossy black appearance when the screen is switched off,
said layer comprises a face located on the side of said at least one screen, which comprises at least one area comprising a coating, preferably black, to form said at least one opaque, preferably shiny, portion, and at least one area not comprising such a coating, to form said transparent portion and being adapted to, by its transparency and its own coloration associated with a black screen placed behind this surface, give the same appearance, preferably shiny black, as that of the opaque area; the coating can be black and shiny and/or deep; the coating can be obtained by serigraphy or by painting, for example, black on the back; the coating allows to modify the appearance of the window by enlarging it or giving it a new and more varied shape not achievable with a traditional window whose height must disappear in the door when it is opened with therefore a certain cylindricity and flatness; the frame element visually enlarges the window, for example from below, or allows it to take on impossible shapes and curves without affecting its entire opening; the implementation of a screen, rendered almost invisible, in this area therefore also allows to solve a style problem that had no solution until then;
said layer is at least partly tactile;
the trim element defines an aesthetic outer surface and visible by a user of said vehicle, this trim element being able to be constituted by a light band emitted by the screen; in this last case, the trim element is not material but is virtual;
the frame element has a general elongated shape;
said at least one screen has a display surface area representing more than 50%, and preferably more than 80% of the visible surface area of the frame element;
said at least one screen is of the OLED, DEL/LED, LCD, TFT-LCD plasma, fabric or skin type, in particular interactive; said frame element is devoid of window or glass panel;
said frame element comprises at least one camera; this camera is advantageously configured to film towards the front, the back, the bottom and/or one side of the vehicle;
said frame element comprises at least one projector, such as for example a laser head or LED spotlight, potentially adjustable, configured to project information onto a member of the vehicle, for example upwards onto a window or downwards onto a casing or onto the ground;
said frame element comprises at least one radar, and/or at least one loudspeaker, and/or at least one proximity sensor, and/or at least one lidar, and/or at least one actuator, and/or at least one solar or thermoelectric sensor allowing for generating or recovering electricity, and/or at least one battery allowing for storing and restoring electricity;
the sensor can also be chosen from: an air quality sensor (AQI Air Quality Index). a thermometer, a brightness sensor for back light adaptation, a camera for recognition, an accelerometer, a microphone, a pressure sensor for wake up or E-Call, a proximity detector for wake up, a magnetometer (compass), a gyrometer, a hygrometer, etc. said body is at least partly elastically deformable or comprises an elastically deformable portion, and is configured to sealingly cooperate with a member, such as a window;
the frame element comprises at least one device for demisting and/or defrosting and/or washing, for example of the screen, of the camera, etc;
said at least one screen has an elongated shape and is configured to extend over more than 50% of a circumference of the window; it can extend over the entirety of this circumference; it can thus replace the trim elements conventionally used to improve the aesthetics around a window;
said system is attached to said body and is connected to said at least one screen, for example by a wire connection; said system is remote from said body and is connected to said at least one screen, for example by a wired or wireless connection;
the frame element comprises removable attachment means, such as at least one hook or at least one adhesive strip, to a door or opening of the vehicle;
the screen is configured to display at least one message horizontally, with characters having a height greater than or equal to 1cm, preferably greater than or equal to 2 cm and more preferably greater than or equal to 4 cm;
said body comprises a standard portion carrying said screen and a fitting portion configured to be interposed between the standard portion and the vehicle and to allow the attachment of the body to the vehicle;
the fitting portion has a frame shape and comprises an upper edge that extends on at least one side beyond said frame; and
the body comprises a sealed housing for mounting said screen or also said system.

The present invention also relates to a vehicle, in particular a motor vehicle, comprising at least one frame element as described above, this frame element being located to the exterior of the vehicle.

The vehicle according to the invention may comprise one or more of the following characteristics, taken alone or in combination with each other:
the frame element extends over more than 80% of the length of said edge of the window, and preferably over the entire length of this edge;
said at least one screen extends over more than 50% or even 70% of the length of said edge of the window, and preferably over the entire length of this edge;
the vehicle comprises at least two frame elements according to one of the preceding claims, which extend one behind the other along one side of the vehicle and respectively along the edges of two adjacent windows;
said at least one frame element is located on a side, rear or front of the vehicle.

### BRIEF DESCRIPTION OF FIGURES

Further characteristics and advantages of the invention will become apparent from the following detailed description, for the understanding of which reference is made to the attached drawings in which:

FIG. 1 is a schematic side view of a motor vehicle equipped with a plurality of window frame elements according to one embodiment of the invention;

FIG. 2 is a larger scale view of a portion of FIG. 1;

FIG. 3 is a very schematic view of a frame element according to the invention and of some of its components;

FIG. 4 is a schematic cross-sectional view of an embodiment of a frame element according to the invention;

FIG. 5 is a schematic side view of a motor vehicle equipped with a window frame element according to a variant of embodiment of the invention;

FIG. 6 is a schematic perspective view of the window frame element of FIG. 5, and more particularly of its visible face;

FIG. 7 is a schematic perspective view of the window frame element of FIG. 5, and more particularly of its attachment face;

FIG. 8 is a schematic exploded perspective view of a frame element such as the one shown in FIG. 5;

FIG. 9 is a schematic cross-sectional view of the frame element;

FIG. 10 is a schematic crass-sectional view of a vehicle door, and represents the mounting environment of a frame element according to the invention; and

FIG. 11 is a schematic cross-sectional view of the door of FIG. 10 equipped with the frame element of FIGS. 6 to 9.

### DETAILED DESCRIPTION OF THE INVENTION

First, reference is made to FIG. 1 which illustrates a motor vehicle 10. However, the invention is not limited to a motor vehicle and can he applied to other types of vehicles, for example a truck, a train, a subway, etc,

In the following description, the terms “exterior”, “outer” and “interior”, “inner” refer to the exterior and interior of the vehicle, respectively. In the case where an element is located at the interior of the vehicle or oriented towards the interior of the vehicle, this element is located in the passenger compartment or on the side of the passenger compartment of the vehicle. On the other hand, in the case where an element is located to the exterior the vehicle or oriented towards the exterior of the vehicle, this element is located to the exterior of the passenger compartment or on the opposite side of the passenger compartment of the vehicle, When an element is present next to a window of the vehicle, it can be considered that this element is located to the exterior of the vehicle or to the exterior side of the vehicle when the plane in which the window extends separates this element from the passenger compartment of the vehicle. It can then be considered that an element located at the interior of the vehicle or on the interior side of the vehicle, is located with the passenger compartment on a same side as the plane of the window.

The vehicle 10 comprises several characteristics that are well known and therefore will not be described.

In the example shown, the vehicle 10 comprises several glass surfaces, one front, one rear, and two sides. FIG. 1 shows one of the side glass surfaces 12 of the vehicle.

The vehicle here comprises five doors, i.e. four side doors, namely two front doors 14 and two rear doors 16, and a boot door 18. FIG. 1 allows to show a front door 14 and a rear door 16,

The glass surface 12 extends along a major portion of the length of the vehicle 10 and comprises a plurality of separate and adjacent portions 12a , 12b , 12c , 12d .

The front portion 12a comprises a stationary window 20. The rear portion 12d also comprises a stationary window 20, The intermediate portions 12b , 12c comprise movable windows 22 which are carried by the front 14 and rear 16 doors respectively.

Each of the windows 20, 22 is surrounded by a frame that can extend around all or portion of the outline of this window. As used in this application, a window frame element is defined as an element that is part of a window frame and is intended to extend along an edge of this window. A frame element can he attached to a window or at a distance from this window.

Among the frame elements of a window, and in particular of a movable window 22, there is a licker 24 which is a substantially horizontal frame element that delimits a lower or low portion of the frame,

A frame element comprises an at least partly elastically deformable body configured to be carried by a support of the vehicle and to sealingly cooperate with a member of the vehicle. In the case of a licker, its body is attached to a rack of the door 14 or 16 and sealingly cooperates with the movable window 22 of this door.

In addition to at least partly surrounding the windows 20, 22, the frame elements may be configured to surround the entire circumference of the glass surface 12. That is, the frame elements are arranged next to each other along the periphery of the glass surface 12.

The frame elements may also comprise trim elements 26 which are intended to improve the aesthetic rendering of the glass surface 12 and thus of the vehicle, In the example shown, a continuous strip of several successive trim elements extends over the frame elements over the entire circumference of the glass surface 12. These trim elements 26 comprise, for example, metal or metallized profiles.

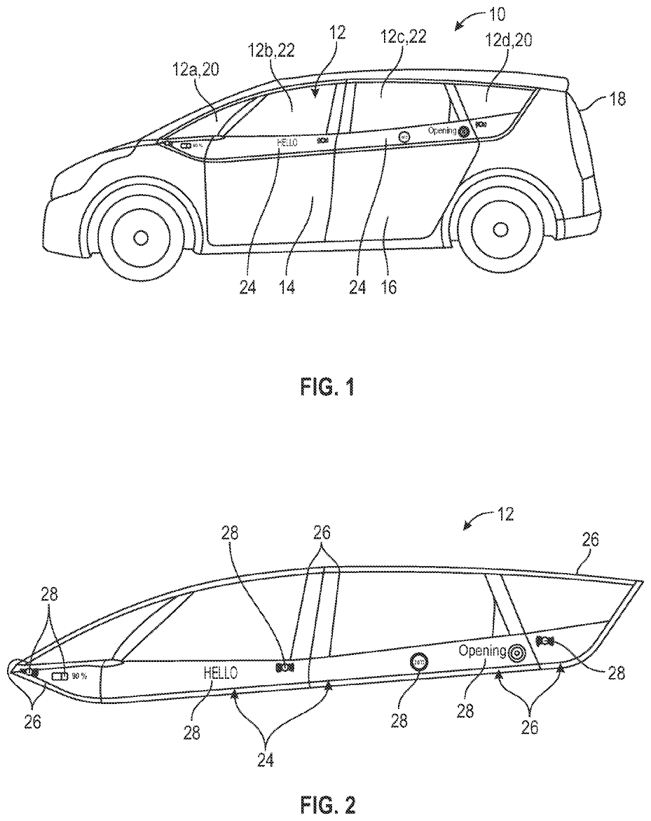

The invention proposes to associate or integrate at least one information display screen with one or more of the frame elements of a vehicle, as best seen in FIG. 2.

Preferably, the screen or the screens are arranged to the exterior of the vehicle, and visible from the exterior of the vehicle.

In the example shown, a plurality of screens 28 are located on frame elements extending along the low portion of the glass surface 12, at the level of its various portions 12a , 12b , 12c , 12d.

The screens 28 are here seven per glass surface 12, although this is not limiting, Each frame element may comprise one or more screens 28, such as up to three or four screens. The screens 28 are of the pixel type, that is, the screens are each in the form of a matrix of basic display units (pixels), this matrix forming a digital image.

The screens 28 can be of various sizes and different from each other. For example, they each have a display surface area greater than 1 cm², and preferably greater than 10 cm².

The screens 28 can have various resolutions or definitions and different from each other, For example, they each have a definition greater than or equal to 50 dpi (i.e, 50 dots per inch or 50 light dots over a length of 2.54cm).

The screens 28 may be spaced apart and distributed over the length of the frame element, or the edge of the window of the glass surface.

The information displayed on each screen can be selected from: an opening and/or closing indication of door of the vehicle, an indicator of the charge level of a battery, in particular of the vehicle, a pressure of the tire or tires of the vehicle, a registration number, in particular of the vehicle, a message that the user has chosen to display on said screen from an electronic device connected to it, in particular his cell phone or srnartphone, an information about the quality of the air inside the vehicle or the air outside, an information in the form of text or colour code representing the pollutant emissions or gas discharges of the vehicle, an information about a preventive or urgent maintenance action to be carried out on the vehicle (deflated tires, oil level to be redone, wear of the brake pads/discs, technical inspection visit to be scheduled or scheduled on a particular date), an information on the state of the bodywork of the vehicle in the context of a rental of the vehicle, the accessibility of the vehicle to persons with reduced mobility, an information on the distance between said vehicle and the vehicles parked on either side of said vehicle, a regulatory information resulting from an activation by the police, a countdown of the remaining parking time, in particular in the context of the payment of this parking, a coded information (OR Code, encrypted message, password) allowing access to certain areas by a visual validation of an exterior device, a colour whose recognition triggers the validation of an access control, a time, a message, an alert, an indication of pollution of the vehicle or of the exterior environment, an indication of autonomous or manual state of the vehicle, an indication of an obstacle near the vehicle, etc.

The screens 28 can be of the OLED, DEL/LED, LCD, plasma, fabric, skin, especially interactive, type etc. They can be tactile so that a user of the vehicle can enter information or make a request.

In general, the screens 26 could integrate all the properties and all the functionalities of the screens of cell phones of the smartphone type.

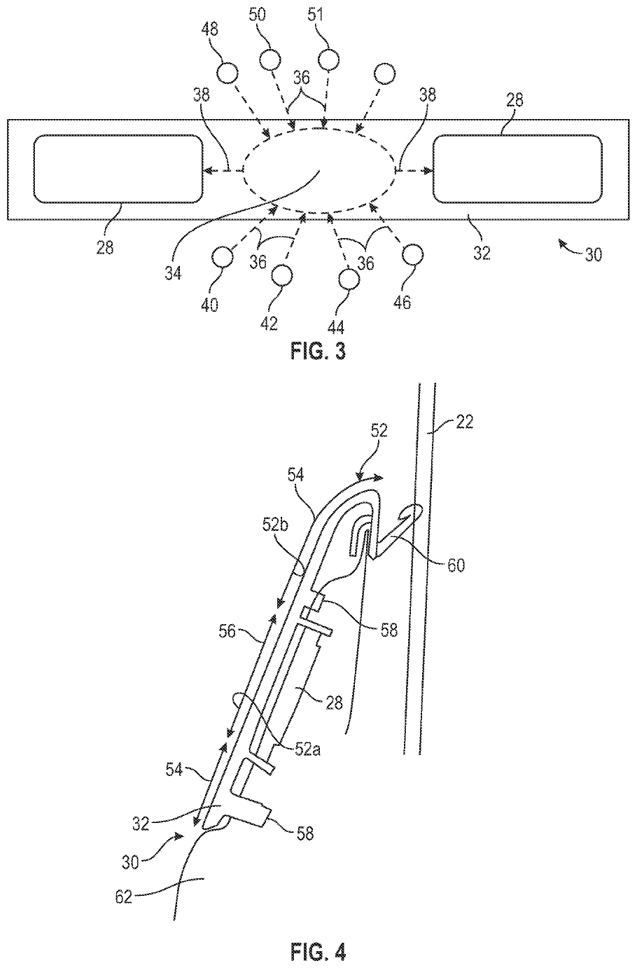

As schematically represented in FIG. 3, a frame element 30 may comprise a body 32 and one or more screens 28 that are connected to a control and communication system 34.

The system 34 may be located to the exterior or to the interior of the vehicle. It can therefore be located on or in the body 32 or at a distance from the latter.

The system 34 is configured to receive first signals 36 and to transmit second signals 38 to the screens 28 that are configured to display information in accordance with those signals 38, or to loudspeakers configured to emit information in accordance with those signals 38.

The com nunication by the system 34 can be done remotely, i.e. wirelessly.

Advantageously, the system 34 is configured to communicate with at least one device selected from a cell phone 40 or an application 42 installed on a cell phone, a sensor 44, a key 46, a CAN data bus 48 of the vehicle, an internet or WiFI network SO, an actuator 51, a camera, a radar, a lidar, a cell allowing to recover energy, an energy storage/emitter, etc.

The sensor may be a door locking/unlocking sensor, a door opening/closing sensor, a window opening/closing sensor, a temperature sensor, a noise or voice sensor, an image or video sensor, a geographic position sensor, a parameter sensor (temperature, pressure, humidity, noise, pollution, etc.), an airbag trigger sensor, a proximity sensor, a radar or a lidar, a fingerprint sensor, a motion sensor, etc. The sensor can be of the ultrasonic, capacitive, accelerometer, gyroscope, tactile, visual, radio frequency type, etc,

The actuator can be an actuator allowing the opening/closing of one or more doors, the appearance of a door handle, a loudspeaker or an electrodynamic or piezoelectric actuator allowing for sounding the surface of this framing to broadcast sounds, warnings, music or spoken messages, etc.

The energy recovery cell is a solar or thermoelectric sensor recovering the light or the heat,

An energy storage/emitter composed of a battery allows to store and restore electricity.

FIG. 4 is a cross-sectional view of a frame element 30. It can be seen that the body 32 and the screens 28 are covered with a layer 52 that is at least partly transparent for viewing the information displayed by the screens 28 through this layer. The layer 52 comprises an outer face 52a oriented towards the exterior of the vehicle and an inner face 52b located on the side of the body 32 and the screens 28 and oriented towards the interior of the vehicle.

The layer 52 may comprise an opaque portion 54 covering the body 32 and transparent or semi-transparent portions 56 covering the screens 28. The inner face 52b of the layer 28 may, for example, be opacified by serigraphy, the opaque serigraphy coating preferably being of a colour close to that of the body 32 to improve the aesthetics of the assembly. The body 32 and the serigraphy are for example black.

FIG. 4 also shows that the body 32 comprises elements 58 for hooking or attaching to a support 62, which in this case is a rack or frame of the door, as well as at least one sealing lip 60 cooperating with the window of this door.

The frame element 30 could itself further comprise at least one sensor and for example an image sensor such as a radar or a camera that can be configured to film towards the front, rear, bottom and/or side of the vehicle, or a sensor from the following list:
air quality sensor (ACII Air Quality Index),
thermometer,
light sensor for back light adaptation,
camera for recognition,
accelerometer,
microphone,
pressure sensor for woke up or E-Call,
proximity detector for wake up.
magnetometer (compass),
gyrorneter,
hygrometer,
etc.

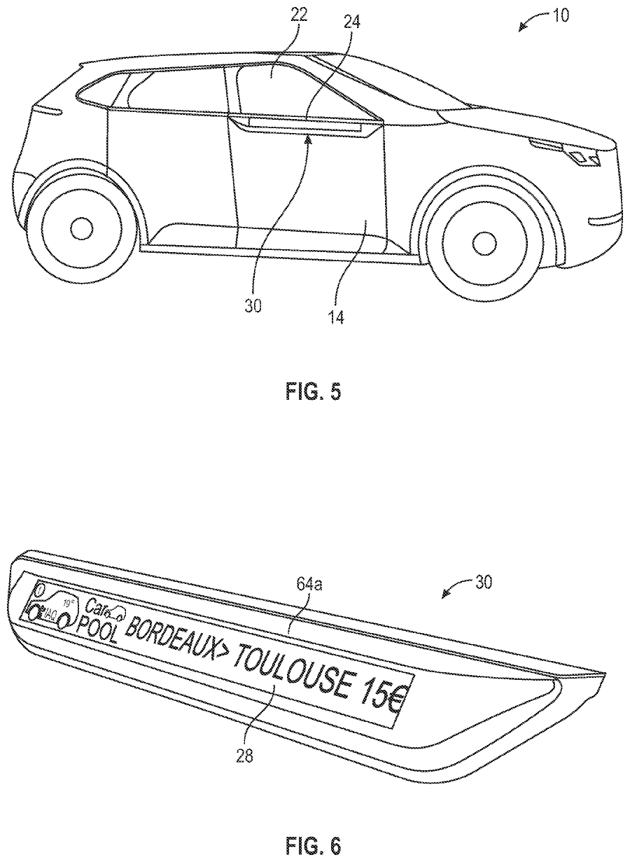

FIGS. 5 to 11 illustrate an alternative embodiment of the invention. The car 10 II) in FIG. 5 is equipped with at least one frame element 30, which is here fitted and attached to a front door 14, to the exterior of the vehicle 10, at the level of the licker 24 of the movable window 22. As in previous embodiments, the mounting of the frame element 30 is riot limited to its mounting on a front door and could naturally be mounted on a rear door, for example, or elsewhere on the vehicle.

The frame element 30 extends over substantially the entire length of the window 22 and the licker 24. It can be attached to the door 14 by gluing and/or hooking, as will be described in more detail below.

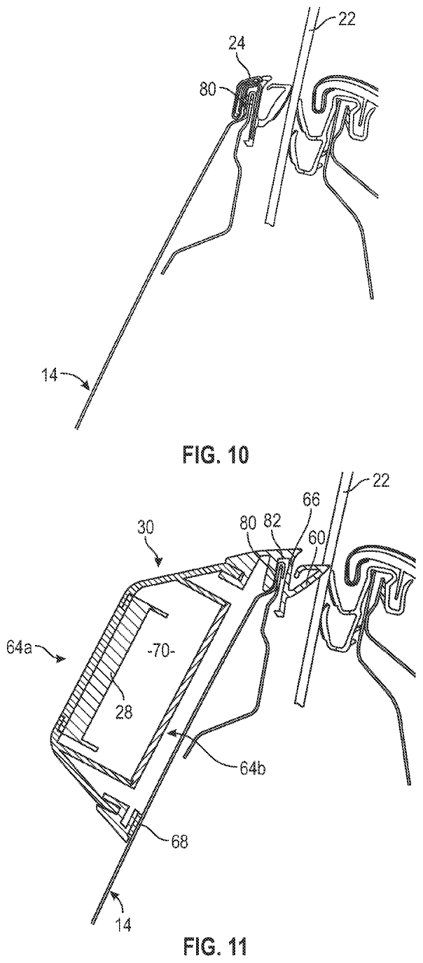

The frame element 30 can cover the original licker 24 of the car 10 or even replace it insofar as the element 30 would be equipped with a substitute licker intended to be mounted in place of the original licker (FIGS. 10 and 11).

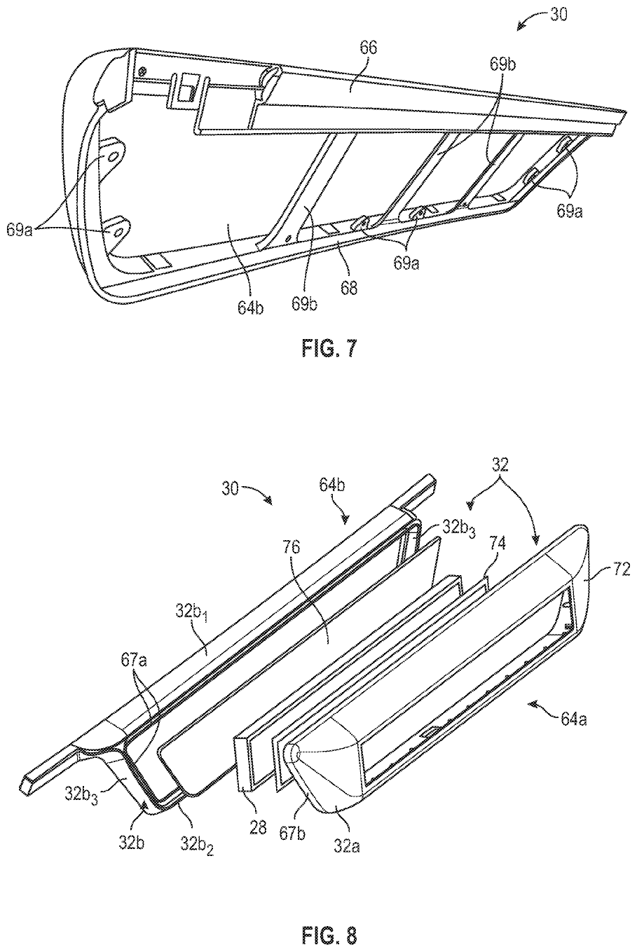

FIGS. 6 and 7 show the visible external 64a and non-visible internal 54b faces of the frame element 30, respectively. The external face 64a is visible by a person outside the vehicle 10. The internal face 64b is intended to be pressed against the door 14 and possibly the licker 24 and comprises attachment means.

The frame element 30 comprises a screen 28 that extends over a major portion of the surface of the external face 64a and is configured to display one or more pieces of information as discussed above, such as logos or messages with a font whose characters have a height greater than or equal to lcm and for example between 2 and 6 cm. The frame element 30 has for example a total height of between 6 and 12 cm. The greater the height of the characters, the more visible and readable the information is from a distance. Ideally, this information is readable from a distance of at least 5 or even 10 meters from the vehicle.

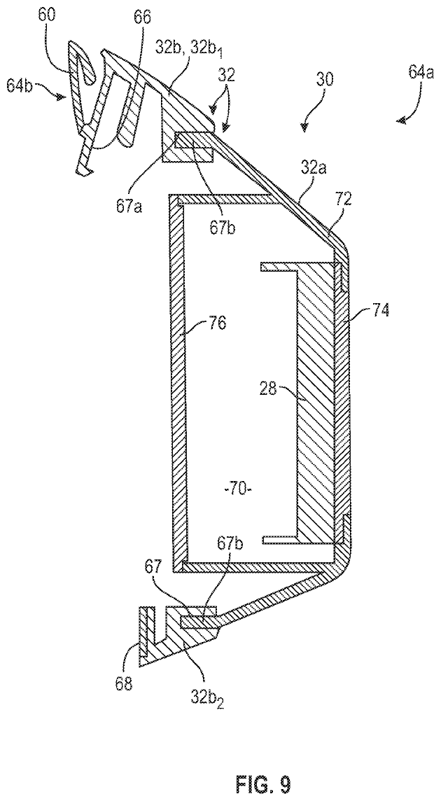

FIGS. 8 and 9 show the various parts of the frame element 30. The element 30 comprises a body 32 which may he in two portions, namely a standard portion 32a common to, for example, several vehicle models, and a fitting portion 32b specific to, for example, a vehicle type.

The standard portion 32a carries the screen 28 and the fitting portion 32b allows the standard portion 32a to be attached to the vehicle 10. It is thus understood that the portion 32b is interposed between the portion 32a and the vehicle 10 and that the portion 32a comprises the means for attaching to the vehicle.

In the example shown, which is not limiting, the portion 32b is in the form of a generally parallelepipedal or rectangular frame, hollow or not hollow. The portion 32b thus comprises two longitudinal and horizontal edges, respectively upper 32b1 and lower 32a2, and two lateral edges 32b3. The upper edge 32b1 extends beyond the side edges 32b3 and has an overall length depending on the length of the window 22 or the licker 24 to be covered or replaced. As can be seen in FIGS. 7 and 9, this edge 32b1 can be equipped, on the side of the face 64h, with a longitudinal hook 66 for attaching to the rack or frame of the door 14 and with a sealing lip cooperating with the window 22 of the door 14. The lower edge 32h2 may be equipped on the side of the face 64b with an adhesive strip 68 intended to be applied to an external face of the door 14, located under the licker 24, Finally, if necessary, the edges 32b2 and 32b3 can comprise orifices 69a for the passage of attachment elements of the screw type or the like. ln order to reinforce the portion 32b , the edges 32b1, 32b2 may be connected by reinforcing legs 69b parallel to the edges 32b3, as seen in FIG. 7.

Finally, the fitting portion 32b comprises, on the side of the visible face 64a , a peripheral groove 67a for mounting a peripheral edge 67b of the standard portion 32a . The portions 32a , 32b can be glued or welded together, for example, at the level of the nesting of the edge 67b into the groove 67a.

The standard portion 32a comprises a housing 70, preferably sealed, which has a generally elongated shape along the element 30 and encloses the screen 28 or even the control and communication system 34. The standard portion 32a comprises three segments 72, 74, 76 in the example shown, knowing that at least some of these segments could be formed in one part, i.e. simultaneously, by bi-material injection for example, or integrated for some of them with the portion 32b.

The portion 32a comprises a first segment 72 that is in the form of a generally parallelepipedal or rectangular frame. The second segment 74 is in the form of a transparent or translucent wall which is arranged on the segment 72, on the side of the visible face 64a , and which doses one side (external) of the aforementioned housing 70. This segment 72 covers the screen 28, which can be directly applied and attached, for example by gluing, to a face of the wall. The segments 72, 74 can be made independently of each other and attached together by gluing for example. Alternatively, they could be made simultaneously by bi-material injection or over-molding.

Alternatively, the fitting 32b and standard 32a portions would be formed in one part or would be connected to each other in a manner other than by nesting and, for example, by a hinge. Alternatively, the segment 74 could be part of the fitter part 32b rather than the standard part 32a . This segment 74 could also be connected by a hinge to the rest of the body.

The last segment 76 is in the form of a wall which is arranged on the segment 72, on the side of the face 64b , and which closes the other side (internal) of the aforementioned housing 70. This segment 76 or wall can be attached on the segment 72 by gluing for example.

FIGS. 10 and 11 show a particular example of mounting this frame element 30 to the door 14 of the vehicle 10. The original licker 24 is removed, allowing to free the exterior horizontal rebate 80 of the rack of the door 14. The hook 66 of the element 30 comprises a longitudinal gorge 82 in which the rebate 80 is engaged. The element 30 is mounted on the door 14 by first presenting its upper edge at the level of the rebate 80, and by engaging this rebate 80 in the gorge 82. The lip 60 then is supported on the window 22 of the door 14. The lower edge of the element 30 is then folded over and applied against the door 14 so that the adhesive strip 68 adheres against the door 14. The disassembling of the element 30 can be made by repeating these steps in reverse order and replacing the original licker 24 on the door 14.

In the event that the system 34 is integrated with the element 30, this system could he mounted in the housing 70. Alternatively, the system 34 would be located elsewhere in the vehicle 10 and would be connected to the screen 28 by, for example, a lap of conductors that would exit the housing 70 on the side of the face 64b and be fed to the system 34 passing through the rack of the door 14.

The frame element 30 according to the invention is preferably fed by an electric battery, which may be the battery of the vehicle or a stand-alone battery and for example a battery embedded in the element 30. in the last variant shown in FIGS. 5 and following, this battery would be located, for example, in the housing 70. In the case where this housing 70 would comprise the system 34 and the battery, this element 30 would be autonomous and a connection to a component of the vehicle could just be useful to recharge this battery unless the element is equipped with a solar panel or the like to ensure this recharge.

1. A window frame element for a vehicle, in particular a motor vehicle, said frame element being substantially horizontal and configured to extend, to the exterior of the vehicle, along a substantially horizontal edge of a window and in the extension of this window, this element comprising a body configured to be carried by a support of the vehicle, characterised in that it further comprises at least one pixel information display screen and a control and communication system, which is configured to receive first signals and to transmit second signals to said at least one screen, which is configured to display information in accordance with said second signals.

2. The frame element of claim 1, wherein the frame element comprises a finishing trim element of a side window, a windshield or a rear window of a vehicle.

3. The frame element of claim 1, wherein the frame element comprises an outer seal or licker of a side window of the windshield or a rear window of a vehicle.

4. The frame element according to claim 3, wherein said system is configured to communicate remotely, i.e. wirelessly.

5. The frame element of claim 1, wherein said system is configured to communicate with at least one device selected from a cell phone or an application installed on a cell phone, a sensor, a key, a data bus of the vehicle, a mobile communication network, WIFI, a radio signal, Bluetooth, local or internet connected, and a near field communicating object (NFC).

6. The frame element of claim 5, wherein said sensor is a door locking/unlocking sensor, a door opening/closing sensor, a window opening/closing sensor, a temperature sensor, a noise or voice sensor, an image or video sensor, a geographical position sensor, a proximity sensor, a radar, a lidar, a fingerprint, facial recognition or remote silhouette or gait recognition sensor, or a solar sensor or a thermoelectric material, e.g. black, allowing to generate current.

7. The frame element according to claim 1, wherein said at least one screen is at least partly tactile and/or said frame element comprises at least one tactile surface or a haptic, radar or video interface, recognizing and interpreting remote gestures.

8. The frame element according to claim 1, wherein said at least one screen is configured to display an information selected from among an indication of opening and/or closing of door of the vehicle, an indicator of a charge level of a battery, in particular of the vehicle, a pressure of the tire or tires of the vehicle, a registration number, in particular of the vehicle, a message and/or an image that the user has chosen to display on said screen from an electronic device connected thereto, in particular his cell phone or smartphone, an information relative to the quality of the air inside the vehicle or the air outside, a communication or alert SMS, an information in the form of text, images or colour code representing pollutant emissions, recommendations or gas discharges from the vehicle, an information on a preventive or urgent maintenance action to be carried out on the vehicle (deflated tires, oil level to be redone, washer level, cooling water level, AdBlue level, wear of the brake pads/discs, technical maintenance feasible on the parking, or controls and maintenance scheduled or to be scheduled on a particular date), an information on the condition of the bodywork of the vehicle in the context of a rental or a sharing of the vehicle, the accessibility of the vehicle to persons with reduced mobility, an information on the distance between said vehicle and the vehicles parked on either side of said vehicle, in particular for the PRM requiring space, a regulatory information resulting from a toll, or an access right or an activation by the police, a countdown of the remaining parking time in particular within the context of the payment for this parking, a coded information allowing to authorize the access to certain areas by an interrogation or visual validation of an outer device, and a colour, a sign or a logo whose recognition triggers the validation of an access control.

9. The frame element according to claim 1, wherein said at least one screen has a display surface area greater than 1 cm², and preferably greater than 10 cm², and/or a resolution or definition greater than or equal to 50 dpi.

10. The frame element according to claim 1, wherein it comprises a plurality of screens for displaying different information.

11. The frame element according to claim 1, wherein said body and said at least one screen are covered by a layer that is at least partly to visualize the displayed information through this layer.

12. The frame element according to the claim 11, wherein said layer comprises at least one opaque portion covering said body and at least one transparent or semi-transparent portion covering said at least one screen.

13. The frame element according to claim 12, wherein said layer comprises a face located on the side of said at least one screen, which comprises at least one area comprising a coating, preferably black, to form said at least one preferably shiny opaque portion, and at least one area not comprising such a coating, to form said transparent portion and adapted to, by its transparency and its own coloration associated with a black screen placed behind this surface, give the same preferably shiny black appearance as the opaque area.

14. The frame element according to claim 13, wherein it comprises at least one trim element defining an aesthetic outer surface and visible by a user of said vehicle, this trim element being able to be constituted by a band or a fitted film of metal or other appearance, different from the preferably black areas, or of a light band emitted by the screen.

15. The frame element according to claim 1, wherein it comprises at least one camera, and/or at least one radar, and/or at least one loudspeaker, and/or at least one projector, and/or at least one proximity sensor, and/or at least one lidar, and/or at least one actuator, and/or at least one solar or thermoelectric sensor allowing for generating or recovering electricity, and/or at least one battery allowing for storing and restoring electricity.

16. The frame element according to claim 1, wherein said body is at least partly elastically deformable or comprises an elastically deformable portion, and is configured to sealingly cooperate with a member, such as a window.

17. The frame element according to claim 1, wherein said at least one screen has an elongated shape and is configured to extend over more than 50% of a circumference of the window.

18. The frame element according to claim 1, wherein said system is attached on or in said body and is connected to said at least one screen, for example by a wire connection.

19. The frame element according to claim 2, wherein said system is remote from said body and is connected to said at least one screen, for example by a wired or wireless connection.

20. The frame element according to claim 1, wherein it comprises removable attachment means, such as at least one hook or at least one adhesive strip, to a door of the vehicle.

21. The frame element according to claim 1, wherein the screen is configured to display at least one message horizontally, with characters having a height greater than or equal to lcm.

22. The frame element according to claim 1, wherein said body comprises a standard portion carrying said screen and a fitting portion configured to be interposed between the standard portion and the vehicle and to allow the attachment of the body to the vehicle.

23. The frame element according to claim 22, wherein the fitting portion has a frame shape and comprises an upper edge that extends on at least one side beyond said frame.

24. The frame element according to claim 1, wherein the body comprises a sealed housing for mounting said screen or also said system.

25. A vehicle, in particular for a motor vehicle, comprising at least one frame element according to claim 1, this frame element being located to the exterior of the vehicle.

26. The vehicle of the claim 25, wherein the frame element extends over more than 80% of the length of said edge of the window, and preferably over the entire length of this edge.

27. The vehicle according to claim 25, comprising at least two frame elements which extend one behind the other along one side of the vehicle and respectively along the edges of two adjacent windows.

28. The vehicle of claim 25, wherein said at least one frame element is located on a side, rear or front of the vehicle.
